(19) United States
(12) Patent Application Publication
(10) Pub. No.: US 2009/0136732 A1
(43) Pub. Date: May 28, 2009

(54) THERMOSET RESIN COMPOSITION

(75) Inventors: Hiroshi Uchida, Kanagawa (JP); Yuko Sakata, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/294,342

(22) PCT Filed: Apr. 2, 2007
(86) PCT No.: PCT/JP2007/057797

§ 371 Date: Sep. 24, 2008

(30) Foreign Application Priority Data
Apr. 3, 2006 (JP) 2006-101806

(51) Int. Cl. B05D 3/10; C08L 71/00; C08L 67/00; B32B 27/38

(52) U.S. Cl. 428/220; 525/408; 524/539; 427/386

(57) ABSTRACT

The present invention provides a thermoset resin composition which contains polycarboxylic acid resin (A) and epoxy resin and/or oxetane resin (B) as essential ingredients and is capable of forming a transparent cured product having improved endurance in hot and humid conditions; an optical film obtained by curing the above-mentioned thermoset resin composition; and a laminated film obtained by applying the above-mentioned thermoset resin composition onto a film substrate and curing it.

### TECHNICAL FIELD

The present invention relates to a thermoset resin composition containing (A) polycarboxylic acid resin and (B) epoxy resin and/or oxetane resin as essential ingredients, wherein the light transmittance of a film having a thickness of about 80 μm made by curing the composition is 90% or more in the whole spectrum of the wavelength from 380 nm to 750 nm; an optical film and a laminated film obtained from the thermoset resin composition; and a liquid crystal display using the film.

### BACKGROUND ART

For a protective layer for a deflecting plate, which is a basic constituent of a liquid crystal display, the following properties are required: no fear of double refraction, high light transmission, great heat resistance and nonhygroscopicity, high mechanical strength, low degree of shrinkage by alternation of temperature and humidity, smooth surface, high resolution, good adhesiveness with an adhesive agent, excellence in appearance, etc.

Conventionally, a cellulose triacetate (TAC) film has been mainly used for a protective layer of a liquid crystal display due to the properties such as high evenness of the film thickness, non-orientation, low double refraction, high degree of transparency and good appearance. However, a TAC film is deficient in dampproof properties and the like, and specifically its low durability at high temperature and humidity has become a problem when used for a large-size liquid crystal display.

Meanwhile, Japanese Laid-Open Patent Publication No. H05-212828 (Patent Document 1) proposes using a norbornene resin film and Japanese Laid-Open Patent Publication No. 2005-092112 (Patent Document 2) proposes using a cured product of an acrylic light-cure resin composition.

On the other hand, though it is known that a cured product of a thermoset resin is generally excellent in heat resistance, studies have not been adequately made on its use for a protective layer of a deflecting plate.

### DISCLOSURE OF THE INVENTION

As mentioned above, the present invention aims to provide a protective layer having improved endurance in hot and humid conditions compared to a conventional product by using a cured product obtained from a thermoset resin which is excellent in heat-resistance for a protective layer of a deflecting plate.

That is, an object of the present invention is to provide a thermoset resin composition capable of forming a transparent cured product having improved endurance in hot and humid conditions; an optical film obtained by curing the above-mentioned thermoset resin composition; and a laminated film obtained by applying the above-mentioned thermoset resin composition onto a film substrate and curing it.

As a result of intensive studies, the present inventors have found that a thermoset resin composition containing (A) polycarboxylic acid resin and (B) epoxy resin and/or oxetane resin as essential ingredients can attain the object mentioned above.

That is, the present invention relates to the thermoset resin composition described in 1 to 7 below, the optical film in 8 to 9, the laminated film in 10 and the liquid crystal display in 11:

1. A thermoset resin composition containing (A) polycarboxylic acid resin and (B) epoxy resin and/or oxetane resin as essential ingredients, wherein the light transmittance of a film having a thickness of about 80 μm made by curing the composition is 90% or more in the whole spectrum of the wavelength from 380 nm to 750 nm.
2. The thermoset resin composition as described in 1 above, wherein (A) polycarboxylic acid resin is a urethane resin containing a carboxyl group.
3. The thermoset resin composition as described in 2 above, wherein the urethane resin containing a carboxyl group is a compound made from
(a) a polyisocyanate compound,
(b) a polyhydroxy compound,
(c) a dihydroxy compound containing a carboxyl group, and
(d) a monohydroxy compound as an optional material.
4. The thermoset resin composition as described in any one of 1 to 3 above, which contains (C) a curing catalyst.
5. The thermoset resin composition as described in 4 above, wherein the molar ratio of carboxyl groups of polycarboxylic acid resin (A) to [epoxy groups and/or oxetane groups of epoxy resin and/or oxetane resin (B)] is 0.5 to 2 and the amount of the curing catalyst (C) is from 0.01 to 10 part by mass based on 100 part by mass of (A) polycarboxylic acid resin.
6. The thermoset resin composition as described in any one of 1 to 5 above, which contains inorganic or organic filler having an average particle diameter of 1 to 100 nm by a dynamic light scattering method.
7. The thermoset resin composition as described in any one of 1 to 6 above, which contains inorganic or organic filler having the same refractive index with that of a cured product obtained by curing the above-mentioned thermoset resin composition.
8. An optical film obtained by curing the thermoset resin composition as described in any one of 1 to 7 above.
9. The optical film as described in 8 above having a thickness of 200 μm or less.
10. A laminated film obtained by applying the thermoset resin composition as described in any one of 1 to 7 above onto a substrate film and curing it.
11. A liquid crystal display wherein at least one of the optical film as described in 8 or 9 above or the laminated film as described in 10 above is used as a member.

The thermoset resin composition of the present invention enables to provide an optical film which has excellent durability at high temperature and humidity. The optical film obtained by curing the thermoset resin composition of the present invention can be suitably used for a protective film of a deflecting plate, a phase difference film, a substrate of antireflection film, a member of a liquid crystal display and the like.

### BEST MODE FOR CARRYING OUT THE INVENTION

Hereinafter, the thermoset resin composition, optical film, laminated film and liquid crystal display of the present invention will be described in more detail.

The thermoset resin composition of the present invention contains (A) polycarboxylic acid resin and (B) epoxy resin and/or oxetane resin as essential ingredients, wherein the light transmittance of a film having a thickness of about 80 μm made by curing the composition is 90% or more in the whole spectrum of the wavelength from 380 nm to 750 nm. Further, the light transmittance of a film made by curing the composition having a thickness of 200 μm is preferably 90% or more in the whole spectrum of the wavelength from 380 nm to 750 nm.

### Polycarboxylic Acid Resin (A):

Examples of polycarboxylic acid resin (A) to be used for the present invention include:
(a) urethane resin containing a carboxyl group,
(b) a resin obtained by adding monocarboxylic acid to epoxy resin and subjecting the resin to reaction with acid anhydride,
(c) copolymer of (meth)acrylic acid or a compound represented by formula (2) as described herein below, or
(d) polyimide, polyamide-imide, polyamide, polyurethane and polyester, each having di-terminated carboxylic acid or acid anhydride.

### (a) Urethane Resin Containing a Carboxyl Group

In the present invention, urethane resin containing a carboxyl group (a) can be used as polycarboxylic acid resin

### (A). The Urethane Resin Containing a Carboxyl Group (a) can be Synthesized by Using, for Example,

(a-1) a polyisocyanate compound,
(a-2) a polyhydroxy compound,
(a-3) a hydroxyl compound containing a carboxyl group and, if necessary,
(a-4) a monohydroxy compound.
(a-1) Polyisocyanate Compound

Examples of polyisocyanate compound (a-1) include aromatic diisocyanates such as 2,4-toluene diisocyanate, 2,6-toluene diisocyanate, diphenylmethane diisocyanate, (o, m, or p)-xylene diisocyanate, 1,5-naphthalene diisocyanate, p-phenylene diisocyanate, 3,3′-methylene ditolylene-4,4′-diisocyanate, 4,4′-diphenylether diisocyanate, tetrachlorophenylene diisocyanate;

aliphatic diisocyanates such as 1,6-hexamethylene diisocyanate, 1,3-trimethylene diisocyanate, 1,4-tetramethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate; alicyclic diisocyanates such as isophorone diisocyanate, 1,4-cyclohexane diisocyanate, methylene-bis(cyclohexyl isocyanate), cyclohexane-1,3-dimethylene diisocyanate, cyclohexane-1,4-dimethylene diisocyanate, norbornene diisocyanate;
and ether type diisocyanates such as 2,2′-diethylether diisocyanate.

Among these diisocyanate compounds, aliphatic diisocyanates such as 1,6-hexamethylene diisocyanate, 1,3-trimethylene diisocyanate, 1,4-tetramethylene diisocyanate, 2,2,4-trimethylhexamethylene diisocyanate, 2,4,4-trimethylhexamethylene diisocyanate, 1,9-nonamethylene diisocyanate, 1,10-decamethylene diisocyanate; alicyclic diisocyanates such as isophorone diisocyanate, 1,4-cyclohexane diisocyanate, methylene-bis(cyclohexyl isocyanate), cyclohexane-1,3-dimethylene diisocyanate, cyclohexane-1,4-dimethylene diisocyanate, norbornene diisocyanate;

and ether type diisocyanates such as 2,2′-diethylether diisocyanate are particularly preferred in terms of photostability and flexibility of a obtained film. One of these diisocyanate compounds can be used independently or two or more kinds thereof may be used in combination.

Further, a small amount of polyisocyanate having three or more isocyanate groups such as triphenylmethane triisocyanate can be used as polyisocyanate compounds (a-1) in the range that does not cause gelation, for example, in the range of less than 50 mol % of whole polyisocyanate compounds.

(a-2) Polyhydroxy Compound

Examples of polyhydroxy compound (a-2) include diol compounds such as an alkylene glycol, an alicyclic diol, an epoxy compound adduct to bisphenol A, a polycarbonate diol, a polyether diol, a polyester diol, a polylactone diol, a polybutadiene diol, a hydrogenated polybutadiene diol, a polyisoprene diol, a hydrogenated polyisoprene diol, a polysilicone having di-terminated hydroxyl groups and a hydrogenated dimer acid.

Examples of the alkylene glycol include ethylene glycol, propylene glycol, 1,3-propanediol, tetramethylene glycol, hexamethylene glycol, 1,9-nonane diol and 1,10-decane diol.

Examples of the alicyclic diol include 1,3-cyclohexane dimethanol, 1,4-cyclohexane dimethanol and hydrogenated bisphenol A.

Examples of the epoxy compound adduct to bisphenol A include bisphenol A ethyleneoxide 2 mole-adduct, bisphenol A ethyleneoxide 4 mole-adduct, bisphenol A propyleneoxide 2 mole-adduct and bisphenol A propyleneoxide 4 mole-adduct.

Examples of the polycarbonate diol include polycarbonate diol components consisting of the following compounds such as 1,3-propanediol, 1,4-butanediol, 1,5-pentanediol, 1,6-hexanediol, 3-methyl-1,5-pentanediol, 1,8-octanediol, 2-methyl-1,8-octanediol, 1,9-nonanediol, 1,10-decanediol, 1,4-cyclohexane dimethanol, 1,3-cyclohexane dimethanol, 1,4-cyclohexane diol, 1,3-cyclohexane diol, tricyclohexane dimethanol and pentacyclo pentadecane dimethanol.

Examples of the polyether diol include polyethylene glycol, polypropylene glycol, polytetramethylene glycol, poly-3-methyltetramethylene glycol and copolymer of these polyether diols.

Examples of the polyester diol include; as carboxylic acid components, saturated aliphatic dicarboxylic acids such as succinic acid and adipic acid, unsaturated aliphatic dicarboxylic acids such as fumaric acid and maleic acid, saturated alicyclic dicarboxylic acids such as hexahydro phthalic acid, unsaturated alicyclic dicarboxylic acids such as tetrahydro phthalic acid, aromatic dicarboxylic acids such as phthalic acid, isophthalic acid, terephthalic acid and naphthalene dicarboxylic acid, those containing carboxylic acid compounds having three or more of carboxyl functional groups such as trimellitic acid and pyromellitic acid; and as polyol components, alkylene glycols such as ethylene glycol, propylene glycol, 1,3-propanediol, tetramethylene glycol, 1,3-butanediol, 2-methyl-1,3-propanediol, 1,5-pentanediol, neopentyl glycol, 1,6-hexane diol and 3-methyl-1,5-pentanediol, alicyclic alcohols such as cyclohexane diol and cyclohexane dimethanol, diols containing aromatic ring such as an ethylene oxide-adduct of bisphenol A and a propylene oxide-adduct of bisphenol A, those containing hydroxy compounds having three or more of hydroxyl functional groups such as glycerine and pentaerythritol.

Among these, in terms of resistance for graze, as dicarboxylic acid components, those containing isophthalic acid; and in terms of crystallinity, as polyol components, alkylene glycols having branch such as propylene glycol, 1,3-butanediol, 2-methyl-1,3-propanediol and 3-methyl-1,5-pentanediol, are particularly preferable.

Example of the polylactone diol include a polycaprolactone diol.

Examples of the polybutadiene diol include a polybutadiene diol mainly having 1,4-repeating units such as poly bd T-15HT (trade name: product of Idemitsu Kosan Co., Ltd.) and a hydroxyl polybutadiene mainly having 1,2-repeating units such as G-1000, G-2000 and G-3000 (each is a trade name: product of Nippon Soda Co., Ltd.).

Examples of the hydrogenated polybutadiene diol include a hydrogenated polybutadiene diol mainly having 1,4-repeating units such as polytail H and polytail HA (each is a trade name: product of Mitsubishi Chemical Corporation) and a hydrogenated polybutadiene diol mainly having 1,2-repeating units such as GI-1000, GI-2000 and GI-3000 (each is a trade name: product of Nippon Soda Co., Ltd.).

Example of the polyisoprene diol include poly IP (trade name: product of Idemitsu Kosan Co., Ltd.).

Example of the hydrogenated polyisoprene diol include EPOL (trade name: product of Idemitsu Kosan Co., Ltd.).

Polysilicone having di-terminated carboxyl groups can be represented, for example, by the following formula (1):

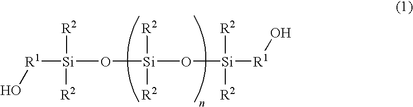

wherein each of R¹ independently represents an alyphatic or aromatic hydrocarbon radical having carbon number 2 to 50, which may contain an ether group, and a plurality of R²s independently represent an aliphatic or aromatic hydrocarbon radical having carbon number 1 to 12.

Examples of hydrogenated dimer acid include Sovermo1908 (trade name, product of Cognis).

Among the diol compounds listed above, using polyester diol is specifically preferable in such a case where the film produced thereof is required to be scuff proof.

As a polyhydroxy compound (a-2), a small amount of a compound(s) having three hydroxyl groups or more such as glycerin, trimethylolethane, trimethylolpropane and pentaerythritol within the range which does not cause gelation, i.e., less than 50 mol % of the entire polyisocyanate compound. These polyhydroxy compounds can be used individually or in combination of two or more.

(a-3) Hydroxyl Compound Having a Carboxyl Group

Examples of a hydroxyl compound having a carboxyl group (a-3) include monoalcohol containing a carboxyl group such as glycol acid and hydroxypivalic acid, and diol containing a carboxyl group such as dimethylol propionic acid, dimethylol butane acid, N,N-bishydroxyethyl glycine and N,N-bishydroxyethyl alanine.

Among these, it is preferable to mainly use diol containing a carboxyl group such as dimethylol propionic acid, dimethylol butane acid, N,N-bishydroxyethyl glycine and N,N-bishydroxyethyl alanine because of the ease of controlling the molecular weight of the obtained urethane, crosslink density of the cured products and the like. It is specifically preferable to use dimethylol propionic acid or dimethylol butane acid mainly due to the solubility to a solvent. These hydroxyl compounds containing a carboxyl group can be used individually or in combination of two or more.

(a-4) Monohydroxy Compound

Urethane resin containing a carboxyl group (a) can be synthesized from only three ingredients of the above polyisocyanate compound (a-1), polyhydroxy compound (a-2) and hydroxyl compound containing a carboxyl group (a-3). However, a monohydroxy compound (a-4) may be added to react with these ingredients in order to impart capability of radical polymerization and cation polymerization and to remove the influence of a terminated isocyanate residue.

Examples of such monohydroxy compound (a-4) include; as alcohols which do not have reactive group other than hydroxyl group, for example, aliphatic monoalcohols such as methanol, ethanol, 1-propanol, isopropanol, n-butanol, isobutanol and t-butanol; those having a radically polymerizable double bond such as 2-hydroxyethyl (meth)acrylate, hydroxypropyl (meth)acrylate and hydroxybutyl (meth)acrylate; and a caprolactone or an alkylene oxide-adduct of any one of these (meth)acrylates, glycerin di(meth)acrylate, trimethylol di(meth)acrylate, pentaerythritol tri(meth)acryalte, dipentaerythritol penta(meth)acrylate, ditrimethylolpropane tri(meth)acrylate, allyl alcohol, allyloxyethanol or the like. One of these monohydroxy compounds may be used independently or two or more kinds thereof may be used in combination.

The urethane resin containing a carboxyl group (a) to be used in the present invention can be obtained by allowing a polyisocyanate compound (a-1), a polyhydroxy compound (a-2), a dihydroxy compound having a carboxyl group (a-3) and when necessary a monohydroxy compound (a-4) to react with each other in an appropriate solvent in the presence or absence of a known urethanization catalyst such as dibutyl tin dilaurate.

The reaction mode is not particularly limited, however, representative examples of the reaction to be implemented on industrial scale are shown below.

Any organic solvent may be used as long as the solvent has low reactivity with isocyanate. Examples of the solvents include tetrahydrofuran, toluene, xylene, ethylbenzene, nitrobenzene, cyclohexane, isophorone, diethyleneglycol dimethylether, ethyleneglycol dimethylether, propyleneglycol methyletheracetate, propyleneglycol ethyletheracetate, dipropyleneglycol methyletheracetate, diethyleneglycol ethyletheracetate, methyl methoxypropionate, ethyl methoxypropionate, methyl ethoxypropionate, ethyl ethoxypropionate, ethyl acetate, n-butyl acetate, isoamyl acetate, ethyl lactate, acetone, methylethyl ketone, cyclohexanone, N,N-dimethyl formamide, N,N-dimethyl acetamide, N-methylpyrrolidone, γ-butyrolactone, dimethyl sulfoxide, chloroform and methylene chloride. Among these, in consideration for solubility of the produced urethane resin containing a carboxyl group, coating properties at the time of forming a film and quick-drying, solvents of diethyleneglycol dimethylether, ethyleneglycol dimethylether, propyleneglycol methyletheracetate, propyleneglycol ethyletheracetate, dipropyleneglycol methyletheracetate, diethyleneglycol ethyletheracetate and γ-butyrolactone are particularly preferred.

With regard to the concentration of the reaction solution, the concentration of urethane resin containing a carboxyl group is preferably 10 to 90 mass %, more preferably 40 to 80 mass %.

There are not special restrictions on the order of charging the materials. However, generally, a polyhydroxy compound (a-2) and a dihydroxy compound containing a carboxyl group (a-3) are charged first and solved in a solvent, and then a polyisocyanate compound (a-1) is added dropwise thereto at 20 to 150° C., preferably at 40 to 120° C., and the mixture is subjected to reaction at 40 to 160° C., preferably at 40 to 130° C.

When the reaction of the polyhydroxy compound (a-2) and the dihydroxy compound containing a carboxyl group (a-3) with the polyisocyanate compound (a-1) is almost completed, the monohydroxy compound (a-4) is added dropwise thereto at 20 to 150° C., preferably at 40 to 120° C., and the mixture is subjected to reaction with isocyanate remaining at terminals at 20 to 150° C., preferably at 40 to 120° C. to complete the reaction.

(b) A Resin Obtained by Adding Monocarbolxylic Acid to Epoxy Resin and Subjecting the Resin to Reaction with Acid Anhydride:

For (A) polycarboxylic acid resin of the present invention, polycarboxylic acid resin can be used, which is synthesized as follows:

(b-1) epoxy resin and (b-2) monocarboxylic acid are subjected to reaction, followed by the reaction with (b-3) acid anhydride.
(b-1) Epoxy Resin

Examples of epoxy resin (b-1) used in the invention include an epoxy compound having two or more of epoxy groups in a molecule such as a bisphenol A type epoxy resin, a hydrogenerated bisphenol A type epoxy resin, a brominated bisphenol A type epoxy resin, a bisphenol F type epoxy resin, a novolak type epoxy resin, a phenol novolak type epoxy resin, a cresol novolak type epoxy resin, an N-glycidyl type epoxy resin, a bisphenol A novolak type epoxy resin, a rubber-modified epoxy resin, a dicyclopentadiene phenolic type epoxy resin, a silicone-modified epoxy resin, a ε-caprolactone-modified epoxy resin, a bisphenol S type epoxy resin, a diglycidyl phthalate resin, a heterocyclic epoxy resin, bixylenol type epoxy resin, a biphenyl type epoxy resin, a glycidyl methacrylate copolymer and an alicyclic epoxy resin.

Among these epoxy resins, specifically preferable are a compound which does not contain a carbon-carbon double bond and a compound which does not contain an aromatic ring such as N-glycidyl epoxy resin, a silicone-modified epoxy resin, a ε-caprolactone-modified epoxy resin, a heterocyclic epoxy resin, a glycidyl methacrylate copolymer and an alicyclic epoxy compound in terms of photostability of the resin produced thereof.

These epoxy resin can be used individually or in combination of two or more.

(b-2) Monocarboxylic Acid

Examples of monocarboxylic acids (b-2) reacted with the epoxy resin (b-1) include saturated aliphatic carboxylic acids such as acetic acid, propionic acid, butanoic acid, isobutanoic acid, valeric acid, isovaleric acid, pivalic acid, t-butyl acetic acid, 2,2-dimethyl butanoic acid, 2-ethyl butanoic acid, n-hexanoic acid, 2-methyl valeric acid, 3-methyl valeric acid, 4-methyl valeric acid, n-heptanoic acid, 2-ethyl-hexanoic acid, n-octanoic acid, 2-propyl valeric acid, nonanoic acid, 3,5,5-trimethyl hexanoic acid, decanoic acid, lauric acid, myristic acid, palmitic acid, isostearic acid and stearic acid;

unsaturated aliphatic acids such as acrylic acid, methacrylic acid, crotonic acid, 3-butenoic acid, 3-methyl crotonic acid, tiglic acid, oleic acid, sorbic acid, cinnamic acid;
saturated alicyclic carboxylic acids such as cyclohexane carboxylic acid;
aromatic carboxylic acids such as benzoic acid, o-toluic acid, m-toluic acid, p-toluic acid, salicylic acid, o-anisic acid, m-anisic acid and p-anisic acid;
hydroxycarboxylic acids such as lactic acid, glycolic acid and hydroxyl pivalic acid;
half ester of saturated aliphatic dicarboxylic acids such as succinic acid, glutaric acid, adipic acid, suberic acid, sebacic acid and dodecanedioic acid;
half ester of saturated alicyclic dicarboxylic acids such as 1,4-cyclohexane dicarboxylic acid;
half ester of unsaturated alicyclic dicarboxylic acids such as tetrahydro phthalic acid, methyltetrahydro phthalic acid, endomethylenetetrahydro phthalic acid and methylendomethylenetetrahydrophthalic acid;
half ester of unsaturated aliphatic dicarboxylic acids such as chlorendic acid, fumaric acid, maleic acid, itaconic acid, citraconic acid and phthalic acid;
and half ester of aromatic dicarboxylic acids such as isophthalic acid, terephthalic acid, 1,4-naphthalenedicarboxylic acid and 2,6-naphthalenedicarboxylic acid.

Among these monocarboxylic acids, particularly preferred are the compounds which do not contain an aromatic ring or a carbon-carbon double bond such as saturated aliphatic carboxylic acids such as acetic acid, propionic acid, butanoic acid, isobutanoic acid, valeric acid, isovaleric acid, pivalic acid, t-butyl acetic acid, 2,2-dimethyl butanoic acid, 2-ethyl butanoic acid, n-hexanoic acid, 2-methyl valeric acid, 3-methyl valeric acid, 4-methyl valeric acid, n-heptanoic acid, 2-ethyl-hexanoic acid, n-octanoic acid, 2-propyl valeric acid, nonanoic acid, 3,5,5-trimethyl hexanoic acid, decanoic acid, lauric acid, myristic acid, palmitic acid, isostearic acid and stearic acid; saturated alicyclic carboxylic acids such as cyclohexane carboxylic acid;

hydroxycarboxylic acids such as lactic acid, glycolic acid and hydroxyl pivalic acid;
half ester of saturated aliphatic dicarboxylic acids such as succinic acid, glutaric acid, adipic acid, suberic acid, sebacic acid and dodecanedioic acid;
and half ester of saturated alicyclic dicarboxylic acids such as 1,4-cyclohexane dicarboxylic acid.

One of these monocarboxylic acids may be used independently or two or more kinds thereof may be used in combination.

(b-3) Acid Anhydride

Examples of acid anhydrides (b-3) to be reacted with the reaction product of epoxy resin (b-1) and monocarboxylic acid (b-2) include saturated alicyclic acid anhydrides such as hexahydro phthalic anhydride and methylhexahydro phthalic anhydride;

saturated aliphatic acid anhydrides such as succinic anhydride, poly(azelaic anhydride), poly(dodecanedioic dianhydride), glutaric anhydride and diethyl glutaric anhydride;
unsaturated aliphatic acid anhydrides such as maleic anhydride, itaconic anhydride, dodecenyl anhydride, chlorendic anhydride and 7,12-dimethyl-7,11-octadecadiene-1,18-dicarboxylic acid partial anhydride;
unsaturated alicyclic acid anhydrides such as tetrahydro phthalic anhydride, methyltetrahydro phthalic anhydride, endomethylenetetrahydrophthalic anhydride and methylendomethylenetetrahydrophthalic anhydride;
and aromatic acid anhydrides such as phthalic anhydride, trimellitic anhydride, pyromellitic anhydride, benzophenone tetracarboxylic anhydride, ethylene glycol bis(anhydro trimellitate) and glycerol tris(anhydro trimellitate).

Among these acid anhydride, specifically preferable are the acid anhydride which does not contain a carbon-carbon double bond or an aromatic ring such as a saturated alicyclic acid anhydride such as hexahydro phthalic anhydride and methyl hexahydro phthalic anhydride; and a saturated aliphatic acid anhydride such as succinic anhydride, polyazelaic polyanhydride, polydodecanedioic dianhydride, glutaric anhydride and diethyl glutaric anhydride in terms of photostability.

These acid anhydrides may be used individually or in combination of two or more.

### (c) Copolymer of (Metha)Acrylic Acid or a Compound Represented by General Formula (2):

As polycarboxylic acid resin (A) of the present invention, a copolymer of a monomer as described herein below and (metha)acrylic acid or a compound represented by the following general formula (2) can be used:

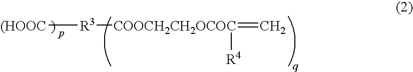

wherein R³ represents an alkylene group, cycloalkylene group or arylene group which may be substituted, R⁴ represents a hydrogen atom or a methyl group, p and q respectively represent an integer of 1 to 3 and p+q≦4.

In the present invention, (meth)acrylic acid means acrylic acid and methacrylic acid. These can be synthesized by a known method or a commercial product may be also available.

Specific examples of the compound represented by above-mentioned general formula (2) include mono(2-hydroxyethyl (meth)acrylate) ester of the following compounds such as succinic acid, itaconic acid, dodecenyl succinic acid, phthalic acid, tetrahydro phthalic acid, methyl tetrahydro phthalic acid, hexahydro phthalic acid, methyl hexahydro phthalic acid, endomethylenetetrahydrophthalic acid, methylendomethylenetetrahydrophthalic acid, chlorendic acid, trimellitic acid, pyromellitic acid, benzophenone tetracarboxylic acid, ethylene glycol bis trimellitate, glutaric acid and diethyl glutaric acid; bis(2-hydroxyethyl (meth)acrylate) ester of the following compounds such as trimellitic acid, pyromellitic acid, benzophenone tetracarboxylic acid, ethylene glycol bis trimellitate and glycerol tris trimellitate; and tris(2-hydroxyethyl (meth)acrylate) of the following compounds such as pyromellitic acid, benzophenone tetracarboxylic acid and ethylene glycol bis trimellitate.

Examples of the monomers which may be used for copolymerization with (metha)acrylic acid or a compound represented by the above-mentioned general formula (2) include methyl (metha)acrylate, ethyl (metha)acrylate, propyl (metha)acrylate, butyl (metha)acrylate, isobutyl (metha)acrylate, t-butyl (metha)acrylate, 2-ethyl hexyl (metha)acrylate, octyl (metha)acrylate, isodecyl (metha)acrylate, lauryl (metha)acrylate, tridecyl (metha)acrylate, stearyl (metha)acrylate, cyclohexyl (metha)acrylate, benzyl (metha)acrylate, styrene and vinyl toluene.

### (d) Polyimide, Polyamide-Imide, Polyamide, Polyurethane and Polyester Having Di-Terminated Carboxylic Acid or Acid Anhydride:

For polycarobxylic resin (A) of the present invention, the following can be used:

(d-1) polyimide having di-terminated carboxyl groups,
(d-2) polyimide having di-terminated acid anhydride,
(d-3) polyamide-imide having di-terminated carboxyl groups,
(d-4) polyamide-imide having di-terminated acid anhydride,
(d-5) polyamide having di-terminated carboxyl groups,
(d-6) polyamide having di-terminated acid anhydride,
(d-7) polyurethane having di-terminated carboxyl groups,
(d-8) polyurethane having di-terminated acid anhydride,
(d-9) polyester having di-terminated carboxyl groups, or
(d-10) polyester having di-terminated acid anhydride.
(d-1) Polyimide having di-terminated carboxyl groups

Polyimide having di-terminated carboxyl groups (d-1) can be synthesized, for example, by a method described in the following synthesis methods (i) and (ii).

Synthesis method (i) includes a method of reacting (1) tetracarboxylic dianhydride and (2) diisocyanate so as to make the molar ratio of (1) to (2) ((1)/(2))>1, followed by the reaction with (3) a monohydroxy compound or a mono secondary amine compound.

Examples of tetracarboxylic dianhydride (1) can be used in the invention include aromatic tetracarboxylic anhydrides such as pyromellitic dianhydride, benzophenonetetracarboxylic dianhydride, pyrazine-2,3,5,6-tetracarboxylic dianhydride, thiophene-2,3,4,5-tetracarboxylic dianhydride and diphenylsulfone tetracarboxylic dianhydride;

aliphatic tetracarboxylic anhydrides such as butane tetracarboxylic dianhydride;
saturated alicyclic tetracarboxylic anhydrides such as decahydro naphthalene-1,4,5,8-tetracarboxylic dianhydride, cyclopentane-1,2,3,4-tetracarboxylic dianhydride, 1,2,3,4-cyclobutane tetracarboxylic dianhydride and bis{exo-bicyclo[2.2.1]heptane-2,3-dicarboxylic anhydride}sulfone;
unsaturated alicyclic tetracarboxylic anhydrides such as 4,8-dimethyl-1,2,3,5,6,7-hexahydro naphthalene-1,2,5,6-tetracarboxylic dianhydride and bicyclo-(2,2,2)-octo(7)-ene-2,3,5,6-tetracarboxylic dianhydride;
and saturated heterocyclic tetracarboxylic anhydrides such as pyrrolidine-2,3,4,5-tetracarboxylic dianhydride and tetrahydrofuran-2,3,4,5-tetracarboxylic dianhydride.

Among these tetracarboxylic anhydrides, in terms of photostability, the tetracarboxylic anhydride which does not contain an aromatic ring or a carbon-carbon-double bond such as aliphatic tetracarboxylic anhydride such as butane tetracarboxylic dianhydride;

saturated alicyclic tetracarboxylic anhydride such as decahydro naphthalene-1,4,5,8-tetracarboxylic dianhydride, cyclopentane-1,2,3,4-tetracarboxylic dianhydride, 1,2,3,4-cyclobutane tetracarboxylic dianhydride and bis{exo-bicyclo[2.2.1]heptane-2,3-dicarboxylic anhydride}sulfone;
saturated heterocyclic tetracarboxylic anhydride such as tetrahydrofuran-2,3,4,5-tetracarboxylic dianhydride;
are particularly preferred.

Examples of diisocyanate (2) include those cited as a compound which can be used for the synthesis of the above-mentioned urethane resin containing a carboxyl group (a). In terms of coloring of the obtained polyimide, coloring of a cured product and photostability, aliphatic diisocyanates such as 1,6-hexamethylene diisocyanate, 1,3-trimethylene diisocyanate, 1,4-tetramethylene diisocyanate, 2,2,4-trimethylhexamethylene diisocyanate, 2,4,4-trimethylhexamethylene diisocyanate, 1,9-nonamethylene diisocyanate and 1,10-decamethylene diisocyanate; alicyclic diisocyanates such as isophorone diisocyanate, 1,4-cyclohexane diisocyanate, methylene-bis(cyclohexyl isocyanate), cyclohexane-1,3-dimethylene diisocyanate and cyclohexane-1,4-dimethylene diisocyanate; ether type diisocyanates such as 2,2′-diethylether diisocyanate; are particularly preferred.

One of these diisocyanates can be used independently or two or more kinds thereof may be used in combination.

Examples of monohydroxy compound (3) include alcohols which does not have reactive group other than hydroxyl group, for example, aliphatic monoalcohols such as methanol, ethanol, 1-propanol, isopropanol, n-butanol, isobutanol and t-butanol; those having a radically polymerizable double bond such as 2-hydroxyethyl (meth)acrylate, hydroxypropyl (meth)acrylate, hydroxybutyl (meth)acrylate, a caprolactone or an alkylene oxide-adduct of any one of these (meth)acrylates, glycerin di(meth)acrylate, trimethylol di(meth)acrylate, pentaerythritol tri(meth) acryalte, dipentaerythritol penta(meth)acrylate, ditrimethylolpropane tri(meth)acrylate, allyl alcohol and allyloxyethanol.

Among these monohydroxy compounds, in terms of coloring of a cured product or photostability, aliphatic monoalcohols such as methanol, ethanol, 1-propanol, isopropanol, n-butanol, isobutanol and t-butanol are particularly preferred.

Meanwhile, examples of mono secondary amine compound (3) include saturated aliphatic secondary amines such as diethylamine and diisopropylamine;

saturated alicyclic secondary amines such as cyclohexylamine;
saturated cyclic amines such as piperidine; unsaturated cyclic amines such as imidazole; and aromatic secondary amines such as N-methyl aniline.

Among these mono secondary amine compounds, in terms of coloring of a cured product or photostability, saturated aliphatic secondary amines such as diethylamine and diisopropylamine, saturated alicyclic secondary amines such as cyclohexylamine and saturated cyclic amines such as piperidine are particularly preferred.

Further, in case where the obtained polyimide is combined with epoxy resin or oxetane resin to produce thermoset composition, in terms of preservation stability, use of monohydroxy compound is preferred rather than use of mono secondary amine compound.

Synthesis method (ii) includes a method of reacting (1) tetracarboxylic dianhydride and (2) diisocyanate so as to make the molar ratio of (1) to (2) ((1)/(2))<1, followed by addition of (3) monohydroxy carboxylic acid or amino acid thereto.

As tetracarboxylic dianhydride (1) and diisocyanate (2) in synthesis method (ii), those illustrated in synthesis method (i) can be used, and for both (1) and (2) specifically preferable are those which does not contain an aromatic ring and a carbon-carbon double bond in terms of coloring of a cured product and photostability.

As the examples of monohydroxycarboxylic acid (3), glycolic acid, hydroroxy pivalic acid and the like can be cited, and as the examples of amino acid, glycine, alanine and the like can be cited.

Among these, when the obtained polyimide is used in combination with an epoxy resin or an oxetane resin, a monohydroxycarboxylic acid is preferably used in the light of preservation stability rather than amino acid.

(d-2) Polyimide Having Di-Terminated Acid Anhydride Groups

Polyimide having di-terminated acid anhydride groups can be obtained by reacting (1) tetracarboxylic acid dianhydride and (2) diisocyanate so that the molar ratio becomes (1)/(2)>1.

As the examples of tetracarboxylic acid dianhydride (1) and diisocyanate (2), those shown in the explanation of the synthesis of polyimide having di-terminated carboxylic acids (d-1) can be used and for both (1) and (2) those containing no aromatic ring or no carbon-carbon double bond are specifically preferably used in the light of the coloring of the obtained polyimide, coloring of a cured product and photostability.

Polyimide having di-terminated carboxylic acids (d-1) or polyimide having di-terminated acid anhydrides (d-2) can be synthesized by other synthesis methods than those above through a polyamide acid by using diamine instead of diisocyanate in each of the above synthesis methods.

Examples of diamines can be used in the invention include aliphatic diamines such as ethylenediamine, tetramethylene diamine, hexamethylene diamine, and N,N′-dimethyl body and diethyl body of any one of these diamines; xylene diamines such as m-xylenediamine and p-xylenediamine, and N,N′-dimethyl substitution, N,N′-diethyl substitution, N,N′-diphenyl substitution and N,N′-dibenzyl substitution of any one of these xylene diamines; piperazines such as piperazine, 2,5-dimethyl piperazine and 1,3-di(4-piperidyl)propane; aromatic diamines such as o-phenylenediamine, m-phenylenediamine, p-phenylenediamine, 3,3′-diaminodiphenylether, 4,4′-diaminodiphenylether, 3,4′-diaminodiphenylether, 3,3′-diaminodiphenylmethane, 3,4′-diaminodiphenylmethane, 4,4′-diaminodiphenylmethane, 3,3′-diaminodiphenyldifluoromethane, 4,4′-diaminodiphenyldifluoromethane, 3,3′-diaminodiphenylsulfone, 3,4′-diaminodiphenylsulfone, 4,4′-diaminodiphenylsulfone, 3,3′-diaminodiphenylsulfide, 2,2-bis(3-aminophenyl)propane, 2,2-bis(3,4′-diaminophenyl)propane, 2,2-bis(4-aminophenyl)propane, 2,2-bis(3-aminophenyl)hexafluoropropane, 2,2-bis(3,4′-diaminophenyl)hexafluoropropane, 2,2-bis(4-aminophenyl)hexafluoropropane, 1,3-bis(3-aminophenyl)benzene, 1,4-bis(4-aminophenyl)benzene, 3,3′-[1,4-phenylenebis(1-methylethylidene)]bisaniline, 3,4′-[1,4-phenylenebis(1-methylethylidene)]bisaniline, 4,4′-[1,4-phenylenebis(1-methylethylidene)]bisaniline, 2,2-bis[4-(3-aminophenoxy)phenyl]propane, 2,2-bis[4-(4-aminophenoxy)phenyl]propane, 2,2-bis[4-(3-aminophenoxy)phenyl]hexafluoropropane, 2,2-bis[4-(4-aminophenoxy)phenyl]hexafluoropropane, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, 9,9-bis(4-aminophenyl)fluorene, and N,N′-dimethyl substitution thereof, N,N′-diethyl substitution thereof, N,N′-diphenyl substitution thereof and N,N′-dibenzyl substitution thereof.

Among these diamines, ethylene diamine; tetramethylene diamine; hexamethylene diamine; xylylene diamine which is an N,N′-dimethyl substitution, N,N′-diethyl substitution, N,N′-diphenyl substitution or N,N′-dibenzyl substitution of these diamines; piperazines such as piperazine, 2,5-dimethyl piperazine, 1,3-di(4-piperidyl) propane and the like are specifically preferable in the light of the coloring of the obtained polyimide, coloring of a cured product and photostability.

(d-3) Polyamide-Imide Having Di-Terminated Carboxyl Groups

Polyamide-imide having di-terminated carboxyl groups (d-3) can be synthesized by the following synthesis methods (i) and (ii).

Synthesis method (i) includes a method of reacting (1) tetracarboxylic acid dianhydride, (2) trimellitic anhydride and (3) diisocyanate so that the molar ratio becomes ((1)+(2))/(3)<1 and adding (1) tetracarboxylic acid dianhydride and (4) a monohydroxy compound or a mono secondary amine compound in this order.

As the examples of (1) tetracarboxylic acid dianhydride, (3) diisocyanate and (4) a monohydroxy compound or a mono secondary amine compound which can be used here, those shown in the explanation of the synthesis of (d-1) polyimide having di-terminated carboxylic acids can be used, and specifically, those containing no aromatic ring or no carbon-carbon double bond are preferably used in the light of coloring of the obtained polyamide-imide, coloring of a cured product and photostability.

Synthesis method (ii) includes a method of reacting (1) tetracarboxylic acid dianhydride, (2) trimellitic anhydride and (3) diisocyanate so as to make the molar ratio of (1)+(2) to (3) (i.e., ((1)+(2))/(3))<1, followed by addition of (4) monohydroxy carboxylic acid, amino acid or dicarboxylic acid thereto.

As tetracarboxylic dianhydride (1), diisocyanate (3) and monohydroxy carboxylic acid or amino acid (4) in synthesis method (ii), those illustrated in synthesis of polyimide having di-terminated carboxyl groups (d-1) can be used, and specifically preferable are those which does not contain an aromatic ring or a carbon-carbon double bond in terms of coloring of a cured product and photostability, respectively.

Further, examples of dicarboxylic acid compound (4) can be used in the invention include saturated aliphatic dicarboxylic acids such as succinic acid, glutaric acid, adipic acid, suberic acid, sebacic acid and dodecanedioic acid; saturated alicyclic dicarboxylic acids such as 1,4-cyclohexanedicarboxylic acid; unsaturated alicyclic dicarboxylic acids such as tetrahydro phthalic acid, methyltetrahydro phthalic acid, endomethylenetetrahydrophthalic acid and methylendomethylenetetrahydrophthalic acid; unsaturated aliphatic dicarboxylic acids such as chlorendic acid, fumaric acid, maleic acid, itaconic acid and citraconic acid;

aromatic dicarboxylic acids such as phthalic acid, isophthalic acid, terephthalic acid and 1,4-naphthalene dicarboxylic acid and 2,6-naphthalene dicarboxylic acid.

Among these dicarboxylic acid compounds, in terms of coloring of a cured product or photostability, saturated aliphatic dicarboxylic acids such as succinic acid, glutaric acid, adipic acid, suberic acid, sebacic acid and dodecanedioic acid and saturated alicyclic dicarboxylic acids such as 1,4-cyclohexanedicarboxylic acid are particularly preferred.

(d-4) Polyamide-Imide Having Di-Terminated Acid Anhydrides

Polyamide-imide having di-terminated acid anhydrides can be obtained by reacting (1) tetracarboxylic acid dianhydride, (2) trimellitic anhydride and (3) diisocyanate so that the molar ratio becomes ((1)+(2))/(3)<1, and adding (1) tetracarboxylic acid dianhydride thereto.

As the examples of (1) tetracarboxylic acid dianhydride and (3) diisocyanate which can be used here, for both (1) and (2) those shown in the synthesis of the above-mentioned polyimide having di-terminated carboxylic acids (d-1) can be used and those containing no aromatic ring or no carbon-carbon double bond are specifically preferably used in the light of coloring of the obtained polyimide, coloring of a cured product and photostability.

(d-5) Polyamide Having Di-Terminated Carboxylic Acids

Polyamide having di-terminated carboxylic acids can be obtained, for example, by reacting (1) dicarboxylic acid and (2) diamine so that the molar ratio becomes (1)/(2)>1.

As the examples of dicarboxylic acid (1) which can be used here, the dicarboxylic acid shown in the synthesis of the above-mentioned polyamide-imide having di-terminated carboxylic acids (d-3) can be used, and as the examples of diamine (2), the diamine shown in the synthesis ((d-1), (d-2) and other synthesis methods) of the above-mentioned polyimide having di-terminated carboxylic acids or acid anhydrides can be listed, and for both (1) and (2) those containing no aromatic ring or no carbon-carbon double bond are specifically preferably used in the light of coloring of the obtained polyamide, coloring of a cured product and photostability.

(d-6) Polyamide Having Di-Terminated Acid Anhydrides

Polyamide having di-terminated acid anhydrides can be obtained, for example, by reacting (1) dicarboxylic acid and (2) diamine so that the molar ratio becomes (1)/(2)<1 and reacting with tetracarboxylic acid dianhydride (3).

The examples which can be used here include, as dicarboxylic acid (1), those shown in the above polyamide-imide having di-terminated carboxylic acids (d-3); as diamine (2), those shown in the synthesis of the above polyimide having di-terminated carboxylic acids or acid anhydrides ((d-1), (d-2) and other synthesis methods); and as tetracarboxylic acid dianhydride (3), those shown in the above polyimide having di-terminated carboxylic acids (d-1). Each containing no aromatic ring or no carbon-carbon double bond is specifically preferably used in the light of coloring of the obtained polyamide, coloring of a cured product and photostability.

(d-7) Polyurethane Having Di-Terminated Carboxylic Acids

Polyurethane having di-terminated carboxylic acids (d-7) can be synthesized by the following synthesis (i) and (ii).

Synthesis method (i) includes a method of reacting (1) polyisocyanate compound and (2) polyhydroxy compound so that the molar ratio becomes (1)/(2)>1 and then adding (3) monohydroxy carboxylic acid or amino acid thereto.

As the examples of polyisocyanate compound (1) and polyhydroxy compound (2), polyisocyanate compound (a-1) and polyhydroxy compound (a-2) shown in the explanation of the above urethane resin containing a carboxyl group (a) can be used, and among these a diisocyanate compound and a diol compound are preferably used to prevent gelation during reation.

As the examples of monohydroxy carboxylic acid (3) or amino acid which can be used here, those shown in the synthesis of the above polyimide having di-terminated carboxylic acids (d-1) can be cited.

Further, synthesis method (ii) includes a method of reacting (1) diisocyanate and (2) diol so that the molar ratio becomes (1)/(2)<1 and then adding (3) acid anhydride thereto.

As the examples of diisocyanate (1) which can be used here, the diisocyanate shown in the explanation of the synthesis method of the above polyimide having di-terminated carboxylic acids (d-1) can be used, and as the examples of diol (2), polyhydroxy compound (a-2) shown in the explanation of the above urethane resin containing a carboxyl group (a) can be used. As the examples of acid anhydride, acid anhydride (b-3) shown in the explanation of resin synthesis (b), wherein a monocarboxylic acid is added to the above epoxy resin and the resin is reacted with acid anhydride, can be used.

(d-8) Polyurethane Having Di-Terminated Acid Anhydrides

Polyurethane having di-terminated acid anhydrides (d-8) can be synthesized by the following synthesis methods (i) and (ii).

Synthesis method (i) includes a method of reacting (1) polyisocyanate and (2) polyhydroxy compound so as to have the molar ratio of isocyanate groups/hydroxyl groups >1, and then reacting (3) tetracarboxylic acid dianhydride.

As the examples of polyisocyanate (1) and polyhydroxy compound (2) which can be used here, polyisocyanate compound (a-1) and polyhydroxy compound (a-2) respectively shown in the explanation of the above urethane resin containing a carboxyl group (a). Among these, a diisocyanate compound and a diol compound are preferably used to prevent gelation during reaction, and the diisocyanate compound and the diol compound containing no aromatic ring or no carbon-carbon double bond are specifically preferably used for the purpose of coloring of a cured product and photostability.

As the examples of tetracarboxylic acid dianhydride (3), the tetracarboxylic acid dianhydride shown in the explanation of the synthesis of polyimide having di-terminated carboxylic acids (d-1) can be used, and the tetracarboxylic acid dianhydride containing no aromatic ring or no carbon-carbon double bond is specifically preferably used for the purpose of coloring of a cured product and photostability.

Examples of synthesis method (ii) include a method of reacting (1) polyisocyanate compound and (2) polyhydroxy compound so as to have the molar ratio of isocyanate groups/hydroxyl groups <1, and then adding (3) tetracarboxylic acid dianhydride.

As the examples of polyisocyanate compound (1) and polyhydroxy compound (2) which can be used here, polyisocyanate compound (a-1) and polyhydroxy compound (a-2) respectively shown in the explanation of the above urethane resin containing a carboxyl group (a). Among these, a diisocyanate compound and a diol compound are preferably used to prevent gelation during reaction.

As the examples of tetracarboxylic acid dianhydride (3), the tetracarboxylic acid dianhydride shown in the explanation of the synthesis of polyimide having di-terminated carboxylic acids (d-1) can be used, and the tetracarboxylic acid dianhydride containing no aromatic ring and no carbon-carbon double bond is specifically preferably used for the purpose of coloring of a cured product and photostability.

(d-9) Polyester Having Di-Terminated Carboxylic Acids

Polyester having di-terminated carboxylic acids (d-9) can be synthesized by the following methods (i) to (iii).

Examples of synthesis method (i) include the method that (1) polycarboxylic acid and (2) a polyhydroxy compound are reacted so as to have the molar ratio of a carboxyl group/a hydroxyl group >1.

As the examples of polycarboxylic acid (1) which can be used here, the polycarboxylic acid shown in the explanation of the synthesis of polyamide-imide having di-terminated carboxylic acids (d-3) can be used. As the examples of polyhydroxy compound (2), polyhydroxy compound (a-2) shown in the explanation of urethane resin containing a carboxyl group (a) can be used. Among these, dicarboxylic acid and a diol compound are preferably used to prevent gelation during reaction.

Examples of synthesis method (ii) include the method that the ester exchange reaction of (1) dicarboxylic acid diester and (2) polyhydroxy compound is conducted so as to have the molar ratio of an ester bond/a hydroxyl group >1, followed by the ester exchange reaction with (3) monohydroxy carboxylic acid.

The examples of diester of dicarboxylic acid (1) which can be used here include dimethyl ester, diethyl ester and diallyl ester of the dicarboxylic acid shown in the explanation of the synthesis of polyamide-imide having di-terminated carboxylic acids (d-3).

The examples of polyhydroxy compound (2), polyhydroxy compound (a-2) shown in the explanation of the above urethane resin containing a carboxyl group (a) can be used and among these, a diol compound is preferably used to prevent gelation during reaction.

As the examples of monohydroxy carboxylic acid (3), the monohydroxy carboxylic acid shown in the explanation of the synthesis of the above polyimide having di-terminated carboxylic acids (d-1) can be used.

Examples of synthesis method (iii) include the method that the ester exchange reaction of (1) dicarboxylic acid diester and (2) polyhydroxy compound is conducted so as to have the molar ratio of an ester bond/a hydroxyl group <1, and then (3) acid anhydride is added.

As the examples of dicarboxylic acid diester (1) which can be used here, dimethyl ester, diethyl ester and diallyl ester of the dicarboxylic acid shown in the explanation of the synthesis of polyamide-imide having di-terminated carboxylic acids (d-3) can be used.

As the examples of polyhydroxy compound (2), polyhydroxy compound (a-2) shown in the explanation of the above urethane resin containing a carboxyl group (a) can be used and among these, a diol compound is preferably used to prevent gelation during reaction.

As the examples of acid anhydride (3), the acid anhydride shown in the explanation of synthesis of the resin (b-3) in which a monocarboxylic acid is added to the above epoxy resin and then reacted with acid anhydride.

(d-10) Polyester Having Di-Terminated Acid Anhydrides

Polyester having di-terminated acid anhydrides (d-10) can be obtained by reacting (1) dicarboxylic acid or a dicarboxylic acid diester and (2) polyhydroxy compound so as to have the molar ratio of a carboxyl group/a hydroxyl group <1, and then by adding (3) tetracarboxylic acid dianhydride.

As the examples of dicarboxylic acid or dicarboxylic acid diester (1) which can be used here, those shown in the explanation of the synthesis of polyamide-imide having di-terminated carboxylic acids (d-3) can be used. As the examples of polyhydroxy compound (2), polyhydroxy compound (a-2) shown in the explanation of the above urethane resin containing a carboxyl group (a) can be used.

As the examples of tetracarboxylic acid dianhydride (3), the tetracarboxylic acid dianhydride shown in the explanation of the synthesis of polyimide having di-terminated carboxylic acids (d-1) can be used.

Among the above polycarboxylic acid resin (a) to (d), urethane resin having a carboxyl group (a) is preferably used in terms of flexibility, crosslink density and transparency of a cured film.

Further, the number average molecular weight of the above polycarboxylic acid resin is preferably 500 to 100,000, and more preferably 2,000 to 30,000.

If the number average molecular weight is less than 500, flexibility and intensity of a cured film may be diminished, and if the number average molecular weight exceeds 100,000, viscosity becomes too high, which makes the production of a cured film difficult.

The number average molecular weight mentioned herein denotes a value in terms of polystyrene measured by gel permeation chromatography.

Epoxy Resin and/or Oxetane Resin (B):

### (B-1) Epoxy Resin

Examples of epoxy resins which can be used as a component (B) in the invention include bisphenol A type epoxy resins such as epicoat 828, epicoat 1002 and epicoat 1004 (each is a trade name: product of Japan Epoxy Resins Co., Ltd.), bisphenol F type epoxy resins such as epicoat 806, epicoat 807 and epicoat 4005P (each is a trade name: product of Japan Epoxy Resins Co., Ltd.) and YDF-170 (trade name: product of Tohto Kasei Co., Ltd.); phenol novolak type epoxy resins such as epicoat 152 and epicoat 154 (each is a trade name: product of Japan Epoxy Resins Co., Ltd.), EPPN-201 (trade name: product of Nippon Kayaku Co., Ltd.) and DEN-438 (trade name: product of Dow Chemical Company), o-cresol novolak type epoxy resins such as EOCN-125S, EOCN-103S and EOCN-104S (each is a trade name: product of Nippon Kayaku Co., Ltd.); biphenyl type epoxy resins such as epicoat YX-4000 and epicoat YL-6640 (each is a trade name: product of Japan Epoxy Resins Co., Ltd.); polyfunctional epoxy resins such as epicoat 1031S (trade name: product of Japan Epoxy Resins Co., Ltd.), araldite 0163 (trade name: product of Ciba Specialty Chemicals), DENACOL EX-611, DENACOL EX-614, DENACOL EX-614B, DENACOL EX-622, DENACOL EX-512, DENACOL EX-521, DENACOL EX-421, DENACOL EX-411 and DENACOL EX-321 (each is a trade name: product of Nagase Chemicals Ltd.); amine type epoxy resins such as epicoat 604 (trade name: product of Japan Epoxy Resins Co., Ltd.), YH-434 (trade name: product of Tohto Kasei Co., Ltd.), TETRAD-X and TETRAD-C (each is a trade name: product of Mitsubishi Gas Chemical Co., Inc), GAN (trade name: product of Nippon Kayaku Co., Ltd.) and ELM-120 (trade name: product of Sumitomo Chemical Co., Ltd.); heterocycle-containing epoxy resins such as aralditePT810 (trade name: product of Ciba Specialty Chemicals); alicyclic epoxy resins such as epicoat YX8000, epicoat YX8034, epicoat YL6753, epicoat YL7040 and epicoat RXE21 (each is a trade name: product of Japan Epoxy Resins Co., Ltd.) and SUNTOHTO ST-3000 and SUNTOHTO ST-4000D (each is a trade name: product of Tohto Kasei Co., Ltd.), ERL4234, ERL4299, ERL4221 and ERL4206 (each is a trade name: product of Union Carbide Corporation); and CELLOXIDE 2021P, CELLOXIDE 3000 and EHPE 3150 (each is a trade name, product of Daicel Chemical Industries, Ltd.). One of these epoxy resins may be used independently or two or more kinds thereof may be used in combination.

### (B-2) Oxetane Resin

Examples of oxetane resins which can be used as component (B) in the invention include polyoxetane compounds such as 1,4-bis[(3-ethyl-3-oxetanylmethoxy)methyl]benzene, di[1-ethyl(3-oxetanyl)]methylether, phenolnovolak oxetane, terephthalate bisoxetane and biphenylene bisoxetane.

curing Catalyst (C):

It is preferable that a curing catalyst (curing promoter) is contained as component (C) in the above-mentioned thermoset resin of the invention.

In the invention, examples of curing catalyst (C) which can be used in case where epoxy resin is contained as component (B) include amine series compounds such as benzyldimethyl amine (BDMA), imidazole, 2-methylimidazole, 2-undecylimidazole, 2-ethyl-4-methylimidazole, 2-phenylimidazole, 2-phenyl-4-methylimidazole, 1-benzyl-2-methylimidazole, 1,2-dimethylimidazole, 1-benzyl-2-phenylimidazole, 2-heptadecylimidazole, 2-phenyl-4,5-dihydroxyimidazole, 2-phenyl-4-methyl-5-hydroxymethylimidazole, 1-cyanoethyl-2-undecylimidazole, melamine, acetoguanamine, benzoguanamine, 2,4-diamino-6-[2′-methylimidazolyl-(1′)]-ethyl-s-triazine, 2,4-diamono-6-[2′-undecylimidazolyl-(1′)]-ethyl-s-triazine, 2,4-diamono-6-[2′-ethyl-4′-imidazolyl-(1′)]-ethyl-s-triazine and 1,8-diazabicyclo[5.4.0]undecene-7,1,5-diazabicyclo[4.3.0]nonene-5, and salts thereof;

phosphine series compounds such as triphenyl phosphine, tris-(2,6-dimethoxyphenyl)phosphine and salt compounds thereof; organometallic salt; quaternary phosphonium halide and dimethylurea. One of these curing promoters may be used independently or two or more kinds thereof may be used in combination.

Meanwhile, examples of curing catalyst (C) which can be used in case where oxetane resin is contained as component (B) in the invention include onium salts such as tetraethylammonium bromide, tetrabutylammonium bromide, tetraethylphosphonium bromide, tetrabutylphosphonium bromide, tetraphenylphosphonium bromide, triphenylbenzylphosphonium chloride; amines such as triethylamine, tributylamine and 1,8-diazabicyclo[5.4.0]undecene-7,1,5-diazabicyclo[4.3.0]nonene-5; a crown ether complex and triphenyl phosphine. One of these catalysts may be used independently or two or more kinds thereof may be used in combination.

As the mixing ratios of the above polycarboxylic acid resin (A), oxetane resin (B) and curing catalyst (C) of the thermoset resin composition of the present invention, the molar ratio of carboxyl groups of (A) polycarboxylic acid resin/[epoxy groups and/or oxetanyl groups of the epoxy resin and/or oxetane resin (B)] is arranged to be 0.5 to 2, more preferably 0.6 to 1.9, and curing catalyst (C) is blended to be from 0.01 to 10 parts by mass based on 100 parts by mass of polycarboxylic acid resin (A).

### Other Additives:

The thermoset resin composition of the present invention can contain additives like inorganic or organic filler, surfactant, mold lubricant, defoamant or the like as long as the transparency is not diminished.

### Inorganic or Organic Filler:

Addition of inorganic or organic filler is effective in adjusting refractive index of a film and improving water absorption coefficient and hardness of a film.

The examples of inorganic filler to be used in the invention include silica, powdered glass, quartz powder, zirconia, smectite and the like. Among these, zirconia is particularly suitable since most of zirconia particles have a smaller diameter than that of the other fillers and therefore can achieve desired effects by adding a filler without degrading the film performance.

The examples of organic filler include epoxy resin powder, melamine resin powder, urea resin powder, guanamine resin powder, polyester resin powder, silicone powder and the like.

In order to keep the transparency of the film produced from the thermoset resin composition of the present invention, the average particle diameter of the filler is preferably 1 to 100 nm, or the refractive index of the filler is preferably the same as that of the cured product obtained by curing the resin composition of the present invention. Here, the particle diameter is determined by a dynamic light scattering method, and an average particle diameter means a center value of a distribution of the particle diameter. If the average particle diameter of the filler exceeds 100 nm and the refractive index of the filler is different from that of the cured product of the resin composition of the invention, the transparency of the film may be diminished. In view of the balance between the film transparency and ease of compounding, the average particle diameter of the filler is preferably 1 to 10 nm.

Moreover, the filler preferably has no absorption in a visible light region. If the filler which has absorption in a visible light region is used in the resin composition of the present invention, the obtained cured product may be colored, and in this case, the composition is to be unsuitable as an optical film.

### Surfactant:

As the surfactant which can be used in the present invention, anion surfactant having a sodium naphthalenesulfonate group and a sodium benzenesulfonate group, nonion surfactant having a polyalkylene oxy group and cationic surfactant having a tetraalkylammonium group can be cited.

### Mold Lubricant:

As mold lubricant which can be used in the present invention, a stearic acid, butyl stearate, zinc stearate, stearic acid amide, fluorine compounds, silicone compounds and the like can be cited.

### Defoamant:

As the examples of the defoamant which can be used in the present invention, silicone defoamant such as KS-602A, KS-66, KS-603, KS-608, FA600 (each is a trade name: produced by Shin-Etsu Chemical Co., Ltd.) and BYK-A530 (trade name: produced by BYK-Chemie Japan KK); and non-silicone defoamant like BYK-051, BYK-052, BYK-053, BYK-055, BYK-057, BYK-354, BYK-355 (each is a trade name: product of BYK-Chemie Japan KK) and the like can be cited.

### Preparation of a Thermoset Resin Composition of the Present Invention:

There is no limitation for a mixing method and an order of blending at preparation of the thermoset resin composition of the present invention. For example, using an apparatus like a Three-one Motor, a high shear mixer, a planetary mixer, a Beads-mill, a three-roll mill and the like, (A) polycarboxylic acid resin, (B) epoxy resin and/or oxetane resin and (C) curing catalyst and other additives as needed are placed all at once in the apparatus, or each can be subsequently introduced and mixed. The temperature at mixing is 60° C. or less, and preferably 40° C. or less to prevent a curing reaction during mixing.

A cured product of the thermoset resin composition of the present invention:

The film produced by curing the thermoset resin composition of the present invention can be used as an optical film and the like, having a thickness of 200 μm or less as an optical film, which can be appropriately designed as usage. Also, the thermoset resin composition of the present composition can be used as a laminated film which can be obtained by curing the composition applied onto a substrate film. The method of applying and curing to produce the film may be a general one. These films are suitable for a member of a protective layer for a deflecting plate, a phase difference film, an antireflection film, liquid crystal display or the like. The thickness of the film is most preferably 20 to 100 μm.

### EXAMPLES

Hereinafter, the present invention is described in detail with reference to Synthesis Examples and Examples, however, the invention is by no means limited thereto.

### Synthesis Example 1

### Synthesis of Urethane Resin Containing a Carboxyl Group (1)

To a reaction vessel equipped with a stirring apparatus and a thermometer, 98 g of norbornene diisocyanate (NBDI) (product of MITSUI TAKEDA CHEMICALS, NC., trade name: Cosmonate), 122 g of polyester diol (product of KURARAY CO., trade name: KURARAY polyol P-530), 34 g of dimethylol butane acid (product of Nippon Kasei Chemical Co., Ltd., trade name: DMBA) and 251 g of propyleneglycol methyl ether acetate (product of Daicel Chemical Industries, Ltd.) as a solvent were placed, reacted at 100° C. for five hours, and 3.6 g of isobutanol (product of JUNSEI CHEMICAL CO., LTD.) was added and further reacted for two hours. Thus synthesized compounds were made as (1) urethane resin containing a carboxyl group. The number average molecular weight of the urethane resin containing a carboxyl group (1) was 6073, acid number of the solid content, that is, acid number of the resin was 50. The acid number was calculated by the following formula according to JIS K0070 method:

Acid number of resin=(measured acid number of the resin solution)/(concentration of the solid content)

### Synthesis Example 2

### Synthesis of Urethane Resin Containing a Carboxyl Group (2)

To a reaction vessel equipped with a stirring apparatus and a thermometer, 56 g of hydrogenated diphenylmethane diisocyanate (product of Sumika Bayer Urethane Co., Ltd., trade name: Desmodur W), 74 g of polycarbonate diol (product of KURARAY CO., trade name: KURARAY polyol C-1015N), 20 g of dimethylol butane acid (product of Nippon Kasei Chemical Co., Ltd., trade name: DMBA), 98 g of diethyleneglycol dimethyl ether (product of JUNSEI CHEMICAL CO., LTD.) as a solvent, and 0.28 g of dibutyl tin dilaurate (IV) as a catalyst were placed, reacted at 90° C. for four hours, 1.6 g of isobutanol (product of JUNSEI CHEMICAL CO., LTD.) was added and further reacted at 100° C. for 2.5 hours. Thus synthesized compounds were made as urethane resin containing a carboxyl group (2). The number average molecular weight of the urethane resin containing a carboxyl group (1) was 5479, acid number of the solid content, that is, acid number of the resin was 50. The acid number was determined by the same way as described in Synthesis Example 1.

### Examples 1, 2 and 3

### Preparation of Thermoset Resin Composition

The urethane resin containing a carboxyl group (1) and (2) obtained in the Synthesis Examples 1 and 2, epoxy resin (product of DAICEL-CYTEC Company, Ltd., trade name: CELLOXIDE 2021P, epoxy equivalent: 130), a curing catalyst and filler were placed in a container at the formulations of Table 1 shown below, stirred and mixed at 2000 rpm for 10 minutes using a high shear mixer and defoamed using a HYBRID MIXER (product of KEYENCE CORPORATION, apparatus name: HM-300) for 10 minutes. At the formulations of Examples 1 and 2 shown in Table 1, the molar ratio of a carboxyl group in polycarboxylic acid resin (A) to an epoxy group in epoxy resin (B) is nearly 1 in both examples.

TABLE 1

| | | Example 1 | Example 2 | Example 3 |
|---|---|---|---|---|
| Polycarboxylic | Synthesis | 40 | | |
| acid resin (A) | Example 1 | | | |
| | Synthesis | | 40 | 6.4 |
| | Example 2 | | | |
| Epoxy resin | CELLOXIDE | 2.4 | 2.8 | 0.45 |
| (B) | 2021P ¹⁾ | | | |
| Curing | U-CAT18X ²⁾ | 0.79 | | |
| catalyst (C) | 1B2MZ ³⁾ | | 0.12 | 0.09 |
| Filler ⁴⁾ | NZD-8G61-02 | | | 10 |

¹⁾ CELLOXIDE 2021P (trade name, product of Daicel Chemical Industries, Ltd.), epoxy equivalent: 130
²⁾ U-CAT18X (trade name, product of SAN-APRO Ltd.), a curing promoter for epoxy resin
³⁾ 1B2MZ (trade name, product of SHIKOKU CHEMICALS CORPORATION), 1-benzyl-2-phenylimidazole
⁴⁾ Filler (product of Sumitomo Osaka Cement Co., Ltd.), zirconia dispersion
Solvent: propylene glycol monomethyl ether
Solid content: 15%
Zirconia concentration: 10 wt %
Average diameter of zirconia particles: 3 nm (by a dynamic light scattering method)

### Example 4

### Forming a Film

The thermoset resin composition obtained in Examples 1, 2 and 3 was coated on a PET film (25 μm) by a bar coater and heated at 80° C. for fifteen minutes and at 120° C. for three hours.

### Example 5 and Comparative Example 1

### Evaluation of a Film

The evaluation tests of the film obtained in Example 4 and a commercially available cellulose triacetate (TAC) film of Comparative Example were performed by the following method. The results were shown in Table 2.
180-degree bending: the obtained film was doubled over 180-degree by hand and O in the Table indicates the film without white turbidity and crack.
pencil hardness: The hardness of the resin layer on the PET film was measured in accordance with JIS K 5400.
transparency: The light transmittance of the obtained film in the wavelength of 380 to 750 nm was measured. O in the Table shows the film having light transmittance of 90% and more in the full spectrum of the above wavelength and X shows the film having light transmittance of 90% or less in any spectrum. The thickness of the film to be measured was specified to be about 80 μm, i.e., in the range of 80±10 μm. The actual thickness is as in Table 2.
water absorption: measured by B method described in JIS K 7209 (the film was immersed in the boiling water and the amount of water absorption was measured)

TABLE 2

| | | | | Comparative |
|---|---|---|---|---|
| blend | Example 1 | Example 2 | Example 3 | Example 1 |
| film thickness | 80 | 80 | 80 | 80 |
| (μm) | | | | |
| 180-degree | ◯ | ◯ | ◯ | ◯ |
| bending | | | | |
| pencil hardness | H | 6B | 6B | HB |
| transparency | ◯ | ◯ | ◯ | ◯ |
| water | 2.8 | 5.2 | 5.0 | 6.3 |
| absorption | | | | |

As described above, the optical film excellent in resistance, specifically in hot and humid conditions, can be obtained by the present invention. Specifically, the cured product of Example 1 was excellent, having high degree of pencil hardness.

1. A thermoset resin composition containing (A) polycarboxylic acid resin and (B) epoxy resin and/or oxetane resin as essential ingredients, wherein the light transmittance of a film having a thickness of about 80μ in made by curing the composition is 90% or more in the whole spectrum of the wavelength from 380 nm to 750 nm.

2. The thermoset resin composition as claimed in claim 1, wherein (A) polycarboxylic acid resin is a urethane resin containing a carboxyl group.

3. The thermoset resin composition as claimed in claim 2, wherein the urethane resin containing a carboxyl group is a compound made from
(a) a polyisocyanate compound,
(b) a polyhydroxy compound,
(c) a dihydroxy compound containing a carboxyl group, and (d) a monohydroxy compound as an optional material.

4. The thermoset resin composition as claimed in claim 1, which contains (C) a curing catalyst.

5. The thermoset resin composition as claimed in claim 4, wherein the molar ratio of carboxyl groups of polycarboxylic acid resin (A) to [epoxy groups and/or oxetane groups of epoxy resin and/or oxetane resin (B)] is 0.5 to 2 and the amount of the curing catalyst (C) is from 0.01 to 10 part by mass based on 100 part by mass of (A) polycarboxylic acid resin.

6. The thermoset resin composition as claimed in claim 1, which contains inorganic or organic filler having an average particle diameter of 1 to 100 nm by a dynamic light scattering method.

7. The thermoset resin composition as claimed in claim 1, which contains inorganic or organic filler having the same refractive index with that of a cured product obtained by curing the above-mentioned thermoset resin composition.

8. An optical film obtained by curing the thermoset resin composition as claimed in claim 1.

9. The optical film as claimed in claim 8 having a thickness of 200 μm or less.

10. A laminated film obtained by applying the thermoset resin composition as claimed in claim 1 onto a substrate film and curing it.

11. A liquid crystal display wherein at least one of an optical film obtained by curing the thermoset resin composition as claimed in claim 1 a laminated film obtained by applying the thermoset resin composition onto a substrate and curing it is used as a member.
